(19) United States
(12) Patent Application Publication
(10) Pub. No.: US 2010/0139844 A1
(43) Pub. Date: Jun. 10, 2010

(54) TIRE BUILDING CORE HANDLING MECHANISM AND METHOD

(76) Inventor: Dennis Alan Lundell, Akron, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 12/327,911

(22) Filed: Dec. 4, 2008

(51) Int. Cl. B29D 30/12

(52) U.S. Cl. 156/110.1; 156/396; 156/414

(57) ABSTRACT

A core handling apparatus is provided for a tire building core. The handling apparatus includes a base plate; a latching mechanism mounted to the base plate and operably inserting into an axial opening at a remote end of a first spindle mechanism connected to a tire building core assembly. The latching mechanism has a latching member operably engaging the first spindle mechanism from within the axial opening. A handle mechanism mounts to the base plate and extends outward. The handle mechanism rotates under manual power to rotate the core assembly through the latching mechanism into alternate angular orientations. The core handling apparatus latching mechanism moves between a radially retracted position that facilitates a close insertion into the spindle mechanism axial opening and a radially extended second position from within the spindle mechanism axial opening to engage the spindle mechanism.

### FIELD OF THE INVENTION

The present invention relates generally to an assembly and method for moving a tire building core from station to station and, more specifically, to a transport assembly for a spindle supported tire building core.

### BACKGROUND OF THE INVENTION

It is known to support a tire building core or drum by a spindle assembly. The spindle assembly may include opposing spindle mechanisms that extend through opposite sides of a core axial opening and mutually engage. It is necessary in certain applications to transport the core assembly station to station in a tire building or curing line. Apparatus to effect such a relocation is therefore beneficial. One approach is to suspend the core assembly in an inverted condition by one of the spindle mechanisms. The transport apparatus may couple to the spindle assembly latch socket and then lift the core in an upended axially vertical condition. The core and tire thereon may then be moved upended by the transport mechanism between multiple stations in a tire build or curing line.

While working well, known transport and latching mechanisms are relatively complicated, heavy, powered apparatus requiring a significant time interval and a complicated procedure for latching and unlatching to a core assembly. Moreover, engaging the spindle latching end for the purpose of lifting and moving the core assembly and tire may interfere with a subsequent docking of the core assembly to a new station in a tire build or curing line and may make decoupling the transport apparatus from the core assembly problematic. Accordingly, the industry is in need of a relatively simple and low weight assembly for expeditious movement of a tire building core from station to station. The preferred transport mechanism should be easy to deploy, easy to use, require a minimal amount of time to engage and disengage from the core assembly, and effect movement of the core assembly with a minimal risk of damage to a green tire carried by the core.

### SUMMARY OF THE INVENTION

According to one aspect of the invention, a transport apparatus is provided for moving a tire building core having a toroidal core assembly coupled to first and second spindle mechanisms extending from opposite sides of a core assembly axial passage. The transport apparatus includes a jig assembly support frame; a first spreader mechanism and a second spreader mechanism; a first arm mechanism and a second arm mechanism, each arm mechanism having a first arm and a second arm coupled to the support frame and to a respective spreader mechanism. The first and second arms of each arm mechanism operably moving between an open divergent position defining an opening sized to admit a respective spindle mechanism from a respective side of the core assembly therein and a convergent closed position operably capturing the respective spindle mechanism therebetween.

In another aspect, the apparatus includes first and second releasable latch mechanisms for selectively locking the first and second arms of the first and second arm mechanisms in the open and closed positions.

The transport apparatus, in a further aspect, includes lifting means coupled to the jig assembly for operably raising and lowering the support frame and first and second arm mechanisms; and a weigh scale coupled to the lifting means for operably indicating the weight supported by the lifting means.

Still a further aspect is a method for transporting a tire building core of the type described above, the method including: positioning a jig assembly over a tire building core locked within a tire build station, the jig assembly having a first arm mechanism and a second arm mechanism, each arm mechanism having a first arm and second arm coupled to a support frame and to a respective spreader mechanism; moving the first and second arms of each arm mechanism into an open divergent position defining an opening sized to admit a respective spindle mechanism; lowering the jig assembly over the core assembly until each spindle mechanism is received within the opening of a respective arm mechanism; moving the first and second arms of each arm mechanism into a closed convergent position engaging a respective spindle mechanism; raising the tire building core by the spindle mechanisms until the weight of the tire building core is supported by the jig assembly; decoupling the tire building core from the tire build station; and repositioning the tire building core.

### DEFINITIONS

“Aspect ratio” of the tire means the ratio of its section height (SH) to its section width (SW) multiplied by 100% for expression as a percentage.

“Asymmetric tread” means a tread that has a tread pattern not symmetrical about the center plane or equatorial plane EP of the tire.

“Axial” and “axially” means lines or directions that are parallel to the axis of rotation of the tire.

“Camber angle” means the angular tilt of the front wheels of a vehicle. Outwards at the top from perpendicular is positive camber; inwards at the top is negative camber.

“Circumferential” means lines or directions extending along the perimeter of the surface of the annular tread perpendicular to the axial direction.

“Equatorial Centerplane (CP)” means the plane perpendicular to the tire's axis of rotation and passing through the center of the tread.

“Footprint” means the contact patch or area of contact of the tire tread with a flat surface at zero speed and under normal load and pressure.

“Groove” means an elongated void area in a tread that may extend circumferentially or laterally about the tread in a straight, curved, or zigzag manner. Circumferentially and laterally extending grooves sometimes have common portions. The “groove width” is equal to tread surface area occupied by a groove or groove portion, the width of which is in question, divided by the length of such groove or groove portion; thus, the groove width is its average width over its length. Grooves may be of varying depths in a tire. The depth of a groove may vary around the circumference of the tread, or the depth of one groove may be constant but vary from the depth of another groove in the tire. If such narrow or wide grooves are substantially reduced depth as compared to wide circumferential grooves which the interconnect, they are regarded as forming “tie bars” tending to maintain a rib-like character in tread region involved.

“Inboard side” means the side of the tire nearest the vehicle when the tire is mounted on a wheel and the wheel is mounted on the vehicle.

“Lateral” means an axial direction.

“Lateral edges” means a line tangent to the axially outermost tread contact patch or footprint as measured under normal load and tire inflation, the lines being parallel to the equatorial centerplane.

“Net contact area” means the total area of ground contacting tread elements between the lateral edges around the entire circumference of the tread divided by the gross area of the entire tread between the lateral edges.

“Non-directional tread” means a tread that has no preferred direction of forward travel and is not required to be positioned on a vehicle in a specific wheel position or positions to ensure that the tread pattern is aligned with the preferred direction of travel. Conversely, a directional tread pattern has a preferred direction of travel requiring specific wheel positioning.

“Outboard side” means the side of the tire farthest away from the vehicle when the tire is mounted on a wheel and the wheel is mounted on the vehicle.

“Radial” and “radially” means directions radially toward or away from the axis of rotation of the tire.

“Rib” means a circumferentially extending strip of rubber on the tread which is defined by at least one circumferential groove and either a second such groove or a lateral edge, the strip being laterally undivided by full-depth grooves.

“Sipe” means small slots molded into the tread elements of the tire that subdivide the tread surface and improve traction, sipes are generally narrow in width and close in the tires footprint as opposed to grooves that remain open in the tire's footprint.

“Slip angle” means the angle of deviation between the plane of rotation and the direction of travel of a tire.

“Tread element” or “traction element” means a rib or a block element defined by having a shape adjacent grooves.

“Tread Arc Width” means the arc length of the tread as measured between the lateral edges of the tread.

### BRIEF DESCRIPTION OF THE DRAWINGS

The invention will be described by way of example and with reference to the accompanying drawings in which:

FIG. 1 is a perspective view of a tire building core assembly.

FIG. 2 is a side elevation view of a tire building core assembly.

FIG. 3 is an exploded perspective view of a tire building core assembly.

FIG. 4 is a longitudinal section view through a tire building core assembly.

FIG. 5A is a left front perspective view of the core lifting jig.

FIG. 5B is a right front perspective view of the core lifting jig.

FIG. 6 is a top plan view thereof.

FIG. 7 is a front elevation view thereof.

FIG. 8 is a side elevation view thereof.

FIG. 9 is a rear elevation view thereof.

FIG. 10 is a partial sectional view of the weigh scale device taken along the line 10-10 of FIG. 8.

FIG. 11 is a partial sectional view thereof taken along the line 11-11 of FIG. 9.

FIG. 12 is a partial sectional view thereof taken along the line 12-12 of FIG. 8.

FIG. 13 is an enlarged perspective view of a weigh scale component indicator.

FIG. 14A is a front perspective view of a core manipulating device.

FIG. 14B is a rear elevation view thereof.

FIG. 15 is a top plan view thereof.

FIG. 16 is a front elevation view thereof.

FIG. 17A is a longitudinal section view through a core assembly and core manipulating device prior to engagement.

FIG. 17B is a longitudinal section view through a core assembly and core manipulating device subsequent to engagement.

FIG. 17C is an enlarged section view of the core assembly to core manipulating device engagement.

FIG. 18A is a side elevation view of the jig assembly and core manipulating device in an open position prior to engagement with a core assembly.

FIG. 18B is a side elevation view of the jig assembly in a closed position in engagement with a core assembly.

FIG. 18C is a side elevation view of the jig assembly lifting a captured core assembly.

FIG. 19A is a front perspective view of the jig assembly in an open position prior to engagement around a core assembly.

FIG. 19B is a front perspective view of the jig assembly in a closed and latched position around a core assembly.

### DETAILED DESCRIPTION OF THE INVENTION

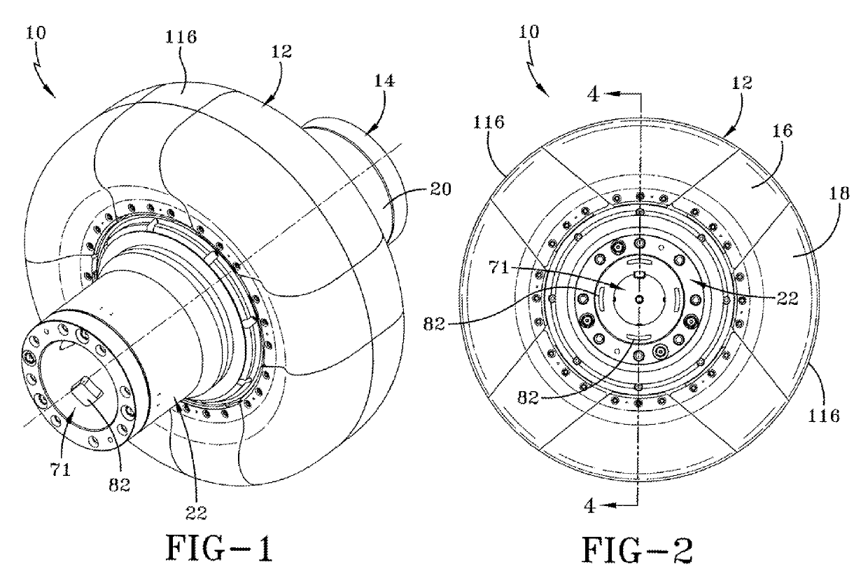

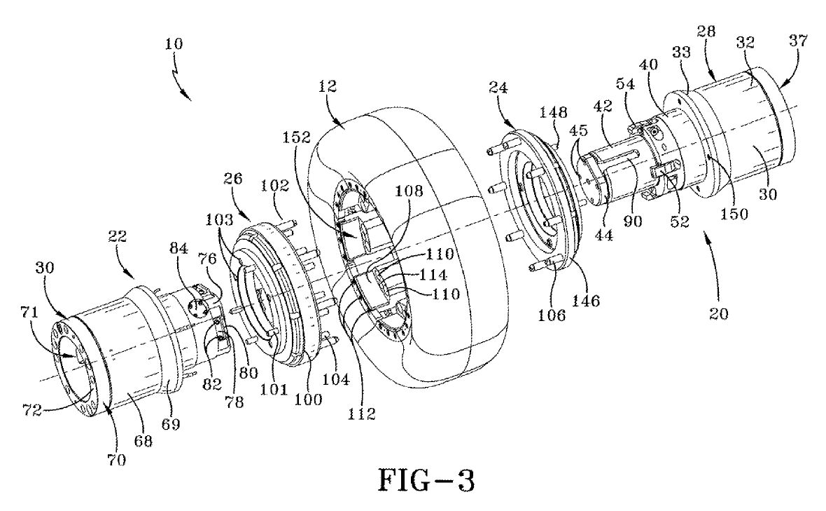

Referring initially to FIGS. 1 and 2, a tire building core assembly 10 is shown in the assembled configuration. The core assembly 10 is described in copending U.S. patent application Ser. No. 11/293,397 filed Dec. 2, 2005, published Jun. 7, 2007, hereby incorporated herein by reference. The core assembly 10 includes a shell assembly 12 configured to provide a toroidal form substantially near final shape and dimension of a final tire. The shell assembly 12 allows for a more accurate placement of tire components in the building of an uncured tire because the tire is built to near final shape. The shell assembly receives an elongate spindle assembly 14 through an axial throughbore of assembly 12. The shell assembly 12 is constructed from alternate shell key segments 16 and large shell segments 18. In general, the tire components are assembled to an outer toroidal surface of the shell assembly 12 to form an uncured tire. The core assembly with uncured tire may then be loaded into a mold for curing. During curing, the core assembly 10 provides additional curing heat through heating elements located on the inside surface of shell segments 16,18. The core is removed from the cured tire by disassembling it and removing the core assembly in segments. The segments are removed from the cured tire, starting with wedge shaped key segments 16. Once the key segments are pulled in radially, they may be removed axially from the tire.

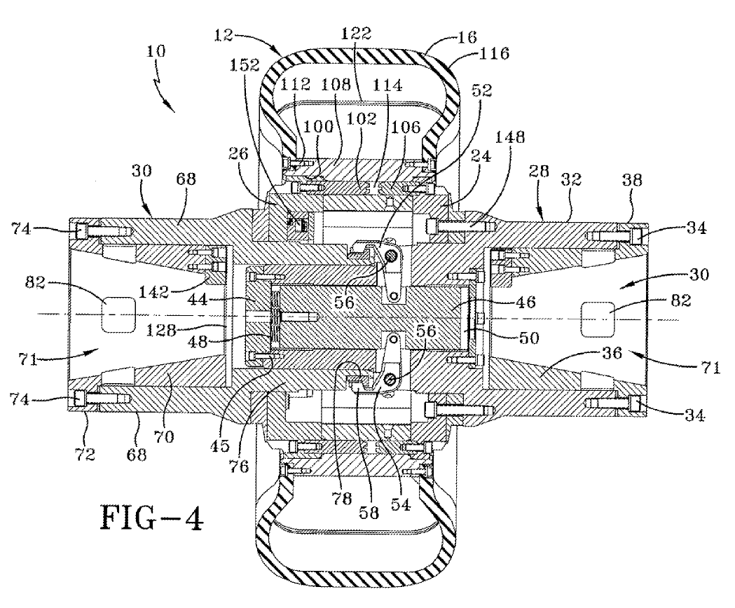

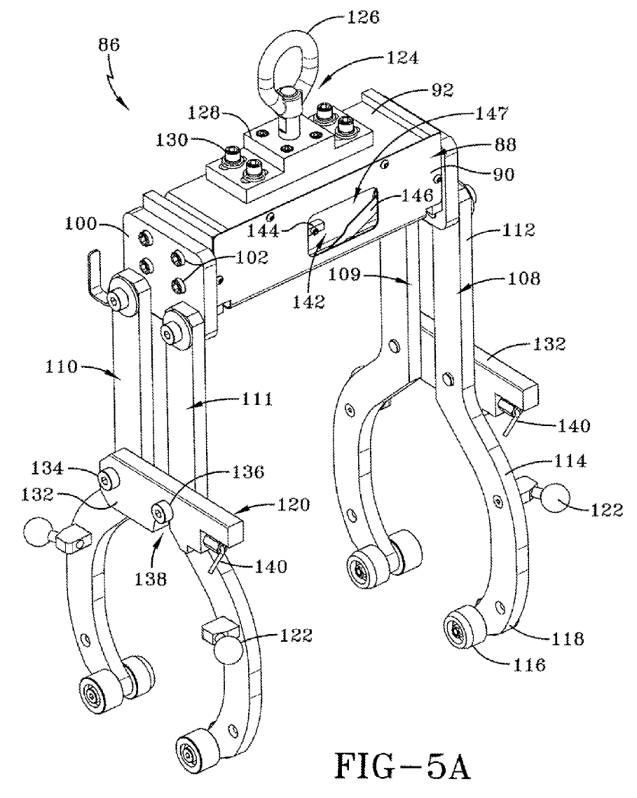

Referring to FIGS. 3 and 4, two mating spindle half assemblies 20,22 (hereinafter referred also to as spindle “units”) including respective ring assemblies 24, 26 join to form the spindle assembly 14. Spindle unit assembly 20 is the latching half of the spindle assembly while generally cylindrical unit assembly 22 is the half of the spindle assembly that electrically services the core assembly.

The spindle unit assembly 20 includes a generally cylindrical outer housing 28 having a rearward housing portion 32 of larger outer diameter, an intermediate housing portion 40 of reduced outer diameter, and a forward housing sleeve portion 42 of reduced outer diameter. An annular flange 33 is disposed approximately at the intersection of rearward housing portion 32 and intermediate housing portion 40. An insert body 36 is received within the body 32 and attaches to portion 32 by means of a peripheral series of attachment screws 34. The insert body 36 has a conical internal axial passageway 37 that tapers through the insert body 36 to the forward cylindrical sleeve portion 42 of the body 32. Retained within the forward sleeve 42 is an elongate cylindrical actuating shaft 46. Shaft 46 resides within an axial passageway 50 through sleeve portion 42 and extends forward to an end cap 44. The end cap 44 attaches to the forward end of sleeve portion 42 by four screws 45. Four latch members (52) are circumferentially spaced around and are pivotally attached to the intermediate portion 40 of the spindle unit housing 28.

FIG. 3 illustrates the two spindle units 20, 22 aligned for mating with the core assembly. Each of the four latch members 52 has an L-shaped latch arm 54 fixedly attached to a peripheral side of the actuator shaft 46. The latch arm 54 of each latch member 53 has an intermediate elbow portion pivotally attached by a pivot pin 64 to the intermediate portion 40 of the outer housing. At the opposite remote end of the arm 54 is a dependent latch flange 58.

As best viewed from FIGS. 3 and 4, the spindle unit housing 30 of the opposite spindle unit 22 includes a cylindrical housing rearward portion 68 of relatively larger outer diameter, a housing forward portion 67 of reduced outer diameter, and a peripheral angled circumferential flange 69 disposed between housing portions 67, 68. An insert body 70 is received within the housing portion 68. An outward extending peripheral flange 72 of the insert body 70 abuts against a rearward rim of the housing portion 68, retained by peripherally located assembly screws 74. A conical passageway 71 extends from the rear into the insert body 70. The outer cylindrical housing 68 has a forward portion 76 having a smaller outer diameter. Four latch plates 78, corresponding in location to the four latch members 52, 54, 56, 58, on the opposite spindle unit, are affixed to the forward housing portion 76 by screws 82. Latch plates 78 each provide a raised tapered flange 80 over which the end 66 of a respective latch member 52 rides to latch the spindle units 20, 22 together within the axial passageway of the core assembly 10.

It will be appreciated that the frustro-conical passageway 71 of each spindle assembly 20,22 is sized to mate with a complementary frustro-conical protrusion within a tire build station (not shown). Each passageway 71 incorporates peripherally spaced detents 82 that receive mating protrusions located within the build station to couple with and retain the core assembly 10 within the station. A tire 84 is built layer by layer upon the shell assembly 12. The core assembly 10 and tire 84 may be moved station to station within a tire build and cure line and the spindle assemblies 20, 22 coupled and decoupled from apparatus within each station. It is necessary, therefore that the core assembly 10 and tire 84 be moved between work stations within the tire building and curing lines.

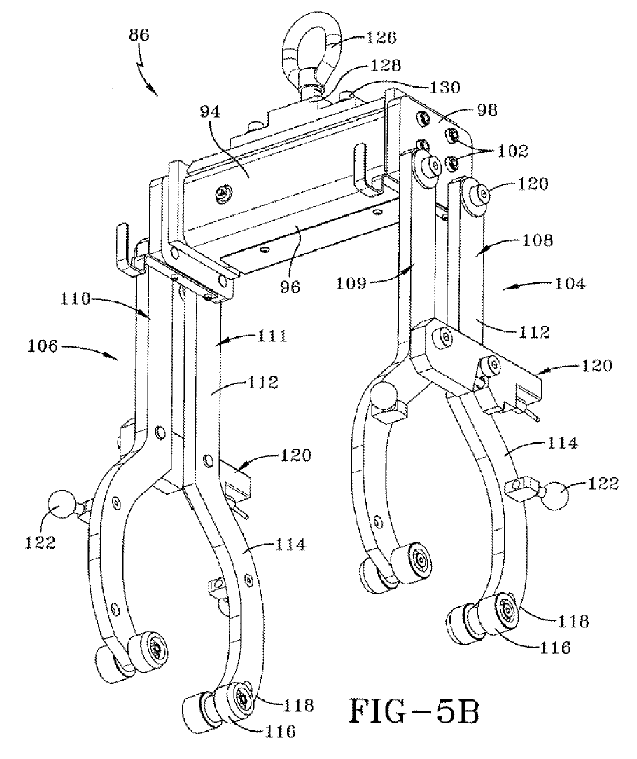

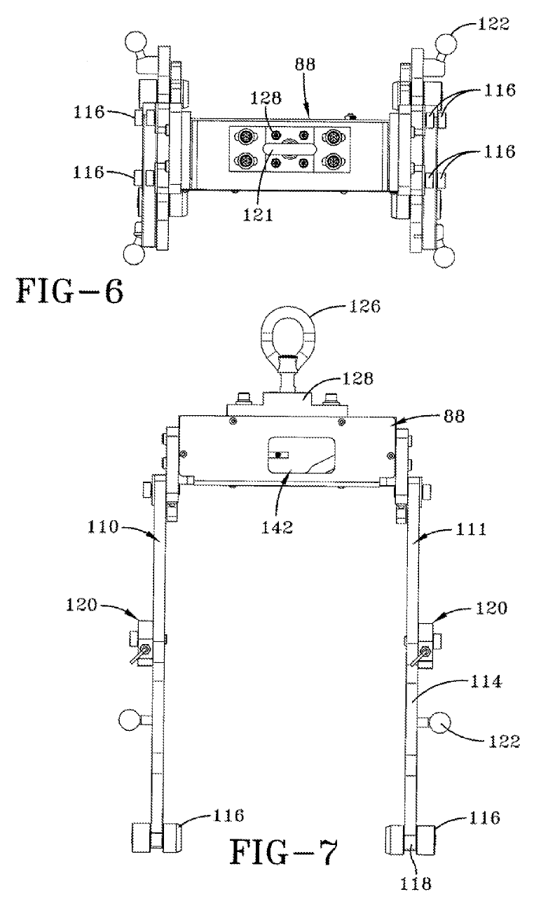

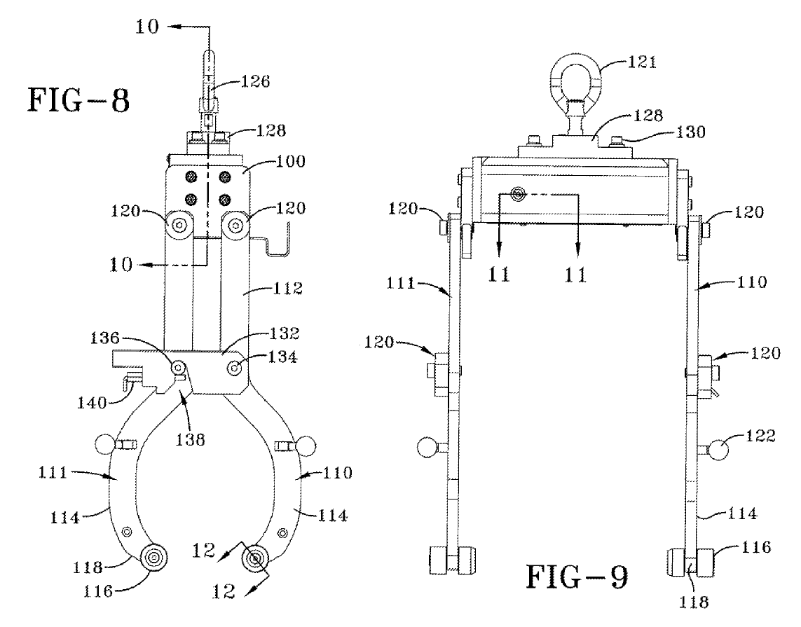

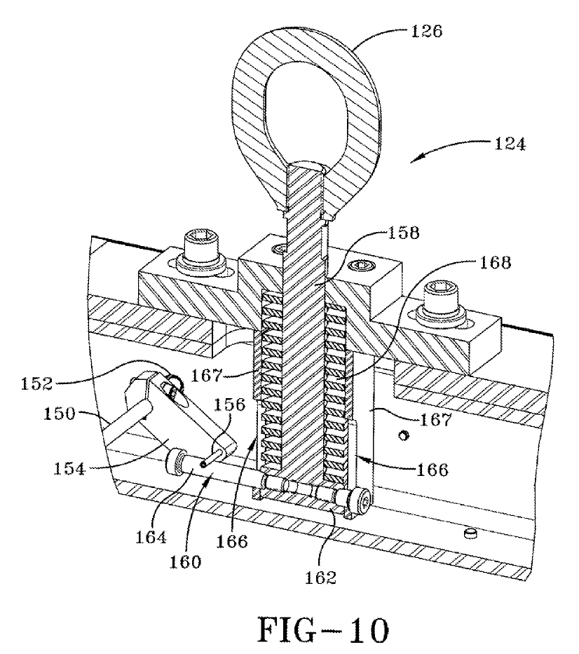

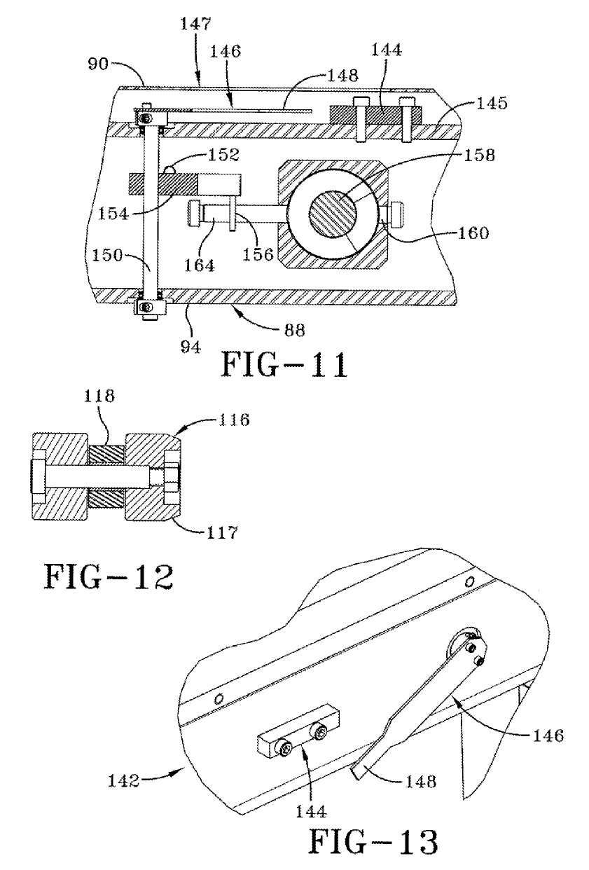

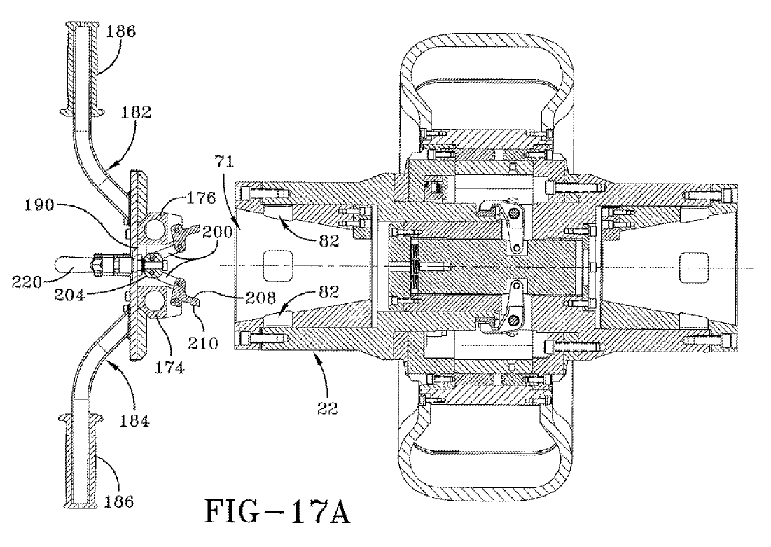

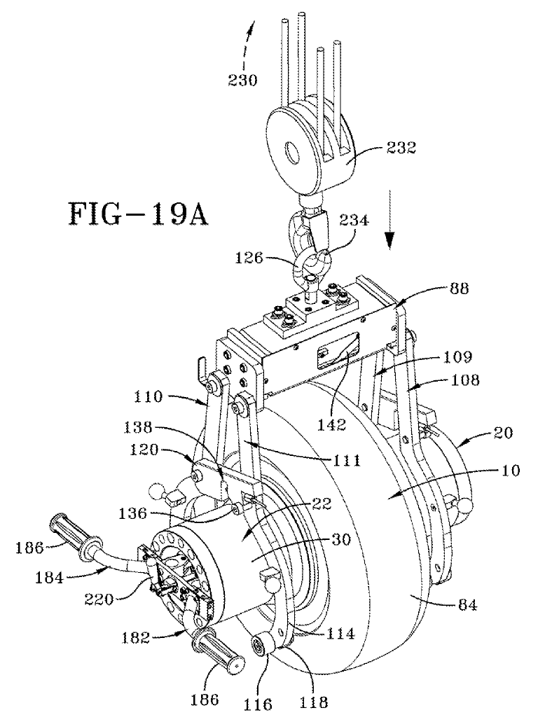

Referring to FIGS. 5A, 5B, 6, 7, 8, and 9, the subject core transport apparatus includes a jig assembly 86 for lifting and laterally transporting the core assembly 10 between tire building and curing line work stations. The jig assembly 86 is configured having an elongate, quadrilateral spreader base 88 formed by rectangular base sidewalls 90, 94, a top wall 92, a bottom wall 96, and end support walls 98, 100. The end support walls 98,100 affix by means of screws 102. Depending from each of the end walls 98, 100 is an elongate arm assembly 104, 106, each having a pair of adjacently extending lifting arms 108, 109, and 110, 111, respectively. The four lifting arms include an elongate upper arm segment 112 and an arcuate lower arm segment 114. The lower arm segments 114 each have a double sided roller 116 rotationally affixed to a lower arm end 118 as best seen in FIG. 12. An inward positioned roller 116 is provided with a chamfer 117 that is angled to abut the annular flanges 69 and 33 of the spindle units 20, 22 when the jig arms 108, 109, 110, 111 are in the core engaging position shown in FIGS. 18B and 18C. The chamfers 117 of the rollers 116 abutting against the spindle flange surfaces 69, 33 thus holds the core assembly in a fixed axial position between the jig arms and deters axial movement of the core assembly during relocation of the core assembly.

The jig assembly 86 further includes a latching mechanism 120 mounted to each arm assembly 104, 106, generally at the intersection of the upper arm segment 112 and the lower arm segment 114 of each arm. Each lifting arm is further provide with an attached handle 122 whereby the lifting arms may be manually moved between divergent and convergent positions as will be explained. A weigh scale assembly 124 is mounted within the spreader base 88 including an eye nut 126. The nut 126 mounts to the upper wall 92 of the base 88 by means of a mounting plate 128 secured to wall 92 by means of attachment screws 130.

With reference to FIGS. 5A, 5B, 18A, and 18B, the latch mechanism 120 consists of a block 132 pivotally attached by means of pivot pin 134 to each of the lifting arms 109,110. Secured to the companion lifting arms 108, 111 is a latch pin 136. A downwardly opening slot 138 extends into an underside of each block 132, sized and positioned for receipt of the latch pin 136 therein. Also extending through each block 132 is a slideably mounted elongate locking pin 140 having a downturned outward end and an inward end positioned to enclose the block 138 of the block when moved inward. It will be appreciated that the latch block 132 when pivoted upwardly as shown in FIG. 18A allows the arms 110, 111 and 108, 109 to be spread apart into a divergent mutual orientation. When the lifting arm pairs are brought together as shown in FIG. 18Band 18C, the latch blocks may be pivoted downwardly so that the latch pins 134 of a respective lifting arm 108, 111 enter into the latch slots 138. Thereafter, the locking pins 140 may be moved inward to lock the pins 134 within respective slots 138, whereby locking the arm pairs 108, 109, and 110, 111 together as shown. Unlatching of latch mechanisms 120 is accomplished in a reverse procedure, whereby releasing the lifting arm pairs and facilitating a divergence of the arm pairs as shown in FIG. 18A.

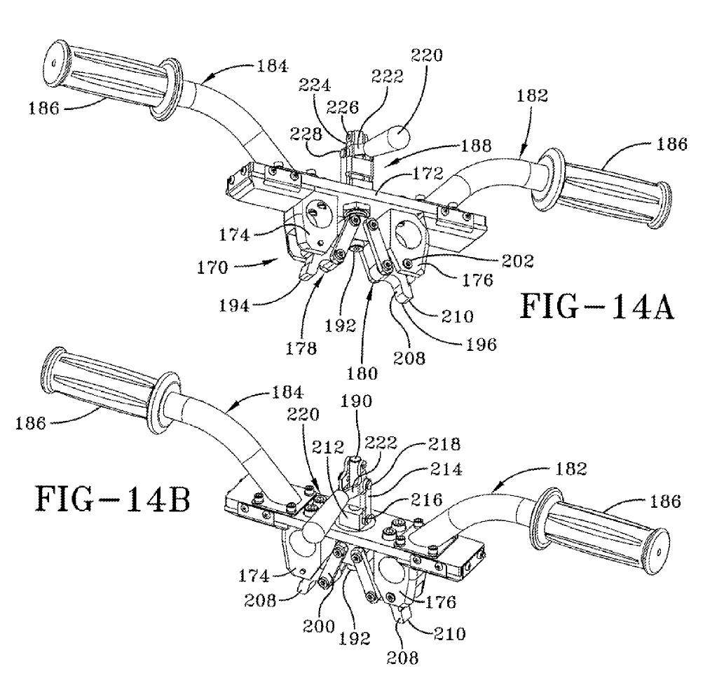

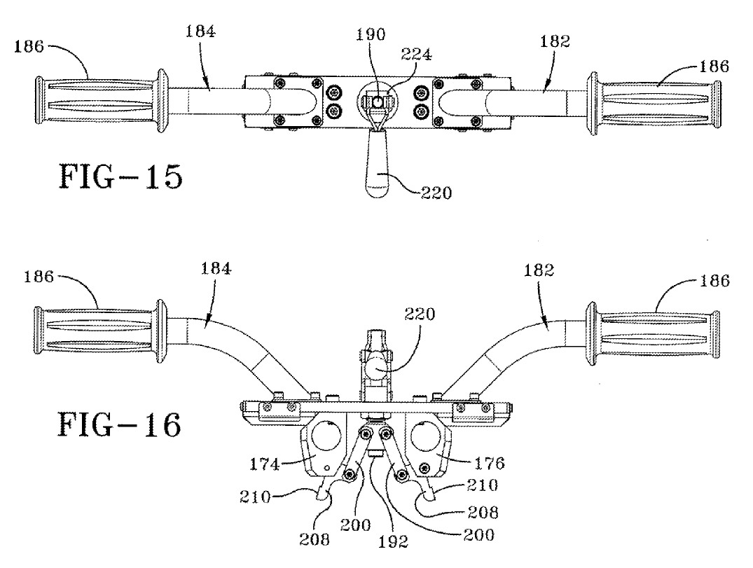

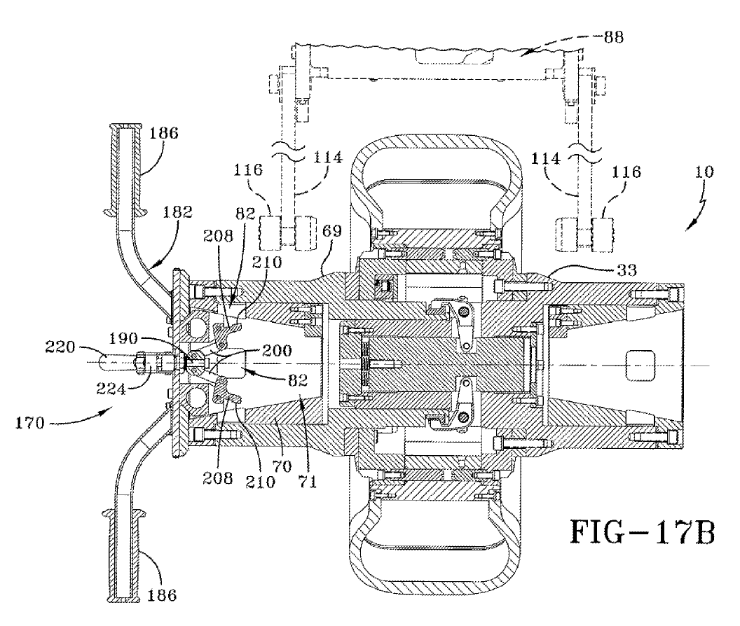

The jig assembly 86 is further provided with a weigh scale and indicator assembly 142 as depicted in FIGS. 5A, 10, 11, and 13. The indicator assembly 142 incorporates a stop flange 144 that mounts to a wall 145 internal to the spreader base 88 and situated behind the forward base sidewall 90. A pivoting weight indicator arm 146 is mounted within the base 88 and is positioned such that a forward end 148 of arm 146 aligns opposite a scale mark 144. A rotational indicator shaft 150 is coupled at one end to the arm 146 and extends through the rearward base sidewall 94. Shaft 150 is coupled an actuator block 154 having an outwardly projecting actuator pin 156 at an inward end of the block 154. The eyelet 126 is affixed to a vertically mounted shaft 158 that is coupled to a cross pin member 160 at a lower end. The pin 160 includes a forward segment 164 situated beneath the pin 156 of the actuator block 154. The shaft 158 extends through a compression spring 168 and both the shaft and spring are housed within a spring housing 167. The cross pin 160 extends through vertical slots 166 within the housing 167 as shown. So positioned, the cross pin is situated to move vertically within the slots 166 against the compression spring 168 to an extent proportional with the weight suspended from the eyelet 126. Movement of the cross pin 160 upward, compresses spring 168 and also actuates a rotation of the actuator block 154 and indicator shaft 150 coupled thereto. Rotation of shaft 150 causes a commensurate pivotal movement of the indicator arm 146. By calibrating spring compression to indicator arm movement, the weigh scale indicator 142 will move the indicator arm 146 into alignment opposite the scale mark 144 whenever the weight load on the eyelet 126 includes a full loading of the core assembly 10 and tire 84. Alignment of the arm segment 148 opposite the scale mark 144 will visually indicate to an operator that the complete transfer of the weight of the core assembly 10 and tire 84 to the eyelet 126 has been completed. The core assembly may thereafter be readily decoupled from the station latching mechanism. The built-in weigh scale in the subject jig assembly thus allows the operator to easily match the lifting force exerted on the eyelet 126 to the weight of the core assembly. This indicates that the weight of the core has been removed from the cone/socket latch mechanism that mounts the core to the tire building or curing station. Binding of the core latch interface with the station is thereby reduced or eliminated, whereby eliminating the need to pry the core from the station when it is released.

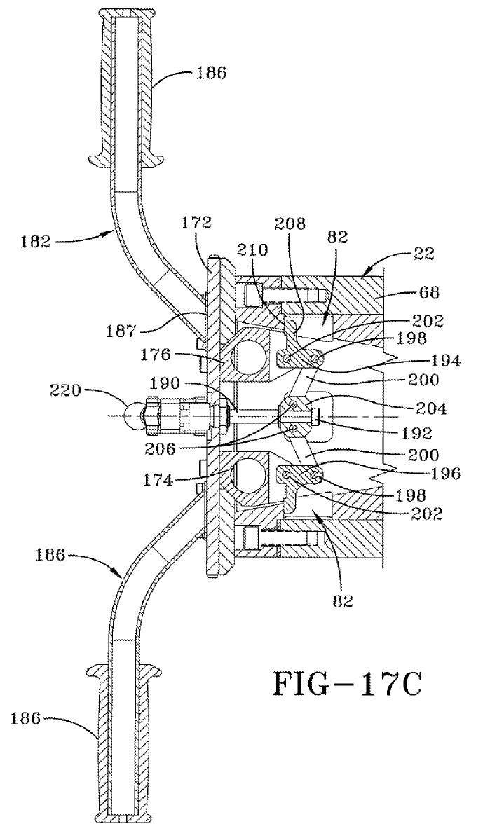

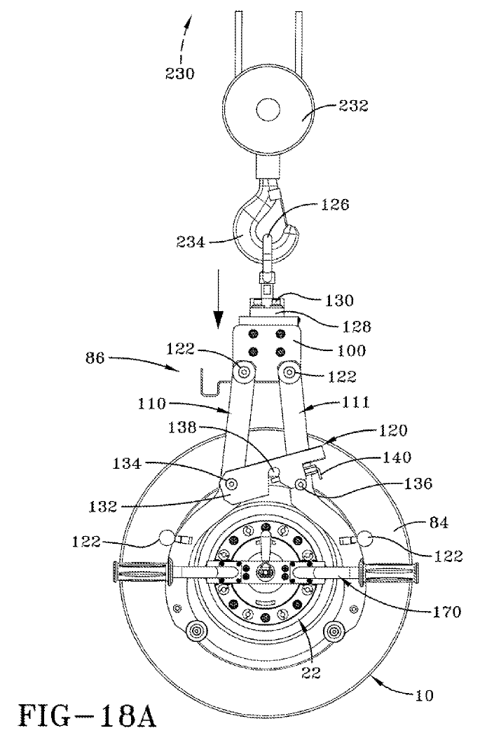

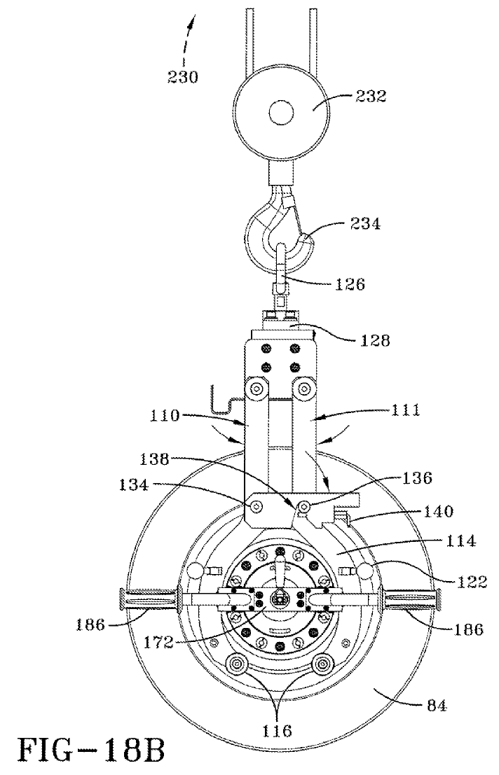

With reference to FIGS. 14A, 14B, 15, 16, 17A, and 17C, a core handling mechanism 170 is shown for axially manipulating and orienting the core assembly 10 with or without the tire 84 mounted thereon, by hand. The mechanism 170 includes a base plate 172 having a pair of spaced apart latch supporting clevis members 174, 176 depending therefrom. Mounted to each of the clevis members is a latch assembly 178, 180, respectively. A pair of handlebars 182, 184 are mounted to an upper surface of the base plate 172 by means of mounting plates 187, each handlebar having an outer handgrip 186. A latch actuation assembly 188 extends through the base plate 172 and includes a vertical shaft 190 extending to a distal lower end cap 192. Two pivoting latch members 194, 196 pivotally mount within the clevis members 174, 176 by a pivot pin 202. The latch members 194, 196 are further coupled at lower portions to an outward end of a respective linkage arm 200. Inward ends of the pivot arms 200 are pivotally coupled to a bracket member 204 by pivot pins 206, with bracket member 204 secured to a lower end of the shaft 190 proximate end cap 192.

Each of the latch members 194, 196 are generally L-shaped, having a latching arm 208 terminating at a latching flange 210. Connecting to the pivot shaft 190 above the base plate 172 is a latch assembly. A base block 212 is secured to the plate 172 and supports a latch bracket 214. Pivotally secured by pin 216 to the bracket 214 is a toggle latching arm 222 having a remote handle 220. The latching arm toggles or pivots between an unlatched vertical orientation and a horizontal latching orientation. Secured by fasteners 226 to the post 190 is a metallic sleeve 224 having formed therein a latching detent 228 located and sized for admission of the latching arm 222.

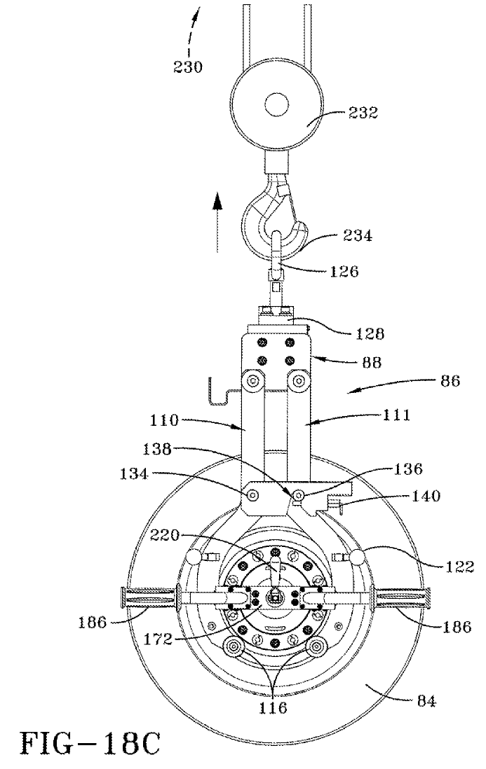

In operation, the post is moveable to a vertically “up” position in which the toggle latch arm 222 is in the vertical unlatched orientation. In the “up” position, post 190 through linkages 200 rotates the latching arms 208 inward into a narrow relative spacing. The spacing of the latch arms 208 is such that the apparatus below the base plate 172 fits within the frustroconical socket 71 of the core spindle insert body 70 as shown in FIGS. 17A and 17B. The base plate 172 abuts against the rearward end of the spindle assembly 22 upon full insertion. In the inserted condition, the latch arms 208 of the mechanism 170 are opposite openings 82 within the spindle assembly socket 71. Thereupon, the handle 220 manually moves the post 190 downward and through linkages 200 pivots the latch members 194, 196 into an outward spacing as shown in FIGS. 17A and 17C. Upon diverging outward, the latching flanges 210 of the latch members 194, 196 enter into openings 82 within the spindle rearward portion 68 and latch against sides defining the openings 82 as shown. Once the latching procedure is completed, the handle 220 is pivoted downward and the handle arm 222 engages the latching detent 228 to hold the core handling mechanism 170 in the core spindle inserted and extended configuration shown. Release of the handle 220 and retraction of the post 190 will disengage the latch members 194, 196 from the core spindle 22 and permit withdrawal of the mechanism 170.

In the inserted, extended, and latched position as seen from FIGS. 18A, B, and 19A, B, the mechanism 170 may be used to impart a rotational torque to the core assembly 10. The handle bars 182, 184 extend outward beyond the circumference of the spindle 22 and is proximally located to a rearward end of the spindle. As such, the mechanism 170 may be readily used to axially rotate and orient the core assembly 10 through the application of a rotating torque and thereby position the opposite spindle 20 of the core assembly 10 for docking to a frustro-conical receiving member within a tire line station. The openings 82 within the spindle 20 may be oriented by the use of the mechanism 170 to align with the latching members of the receiving member for efficient docking of the core assembly 10 thereto. The wide spread of the handlebars of mechanism 170 allow a user to exert sufficient control over the core assembly 10 during re-orientation and docking maneuvers.

It will be appreciated from FIGS. 5A, 18A-C and 19A-B that the core assembly 10 rest on the rollers 116 of the jig assembly lifting arms 108, 109 and 110, 111 when the arms are in a lifting orientation. So positioned, the core may be easily rotated by the handlebars 182, 184. Such rotation is useful in the loading of the core into a tire building or curing station as there is a key (not shown) that must be aligned to set the angular location of the core to the receiving mechanism. However, precisely maintaining a required alignment of the key in the core assembly 10 as it is moved between stations can be problematic. The axial re-alignment of the core facilitated by the handlebars 182, 184 and rollers 116, therefore, is beneficial in re-establishing a desired orientation of the keying element at a given station prior to docking the core assembly. It will further be noted that the mechanism 170 requires no power source, is mechanically reliable, manually operable, and mobile. The mechanism 170 may be transported with the core assembly from station to station without interfering with the tire or core assembly or the transport assembly. In addition, the configuration of the mechanism 170 allows for the efficient manual application of torque force sufficient to achieve the desired axial rotation of the core assembly.

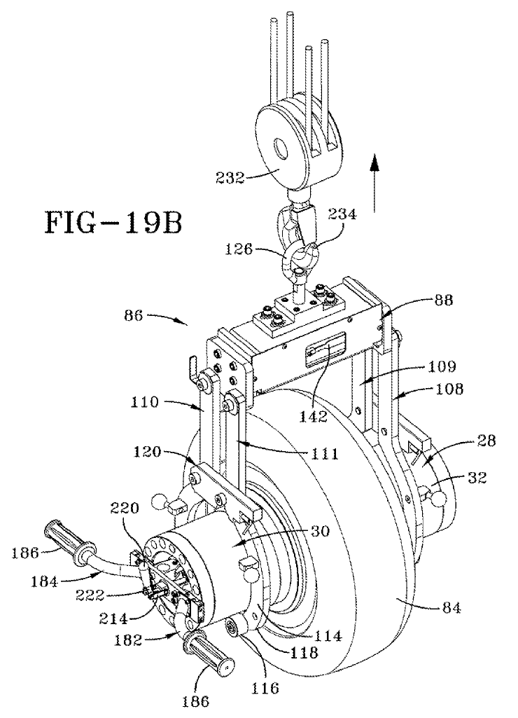

Operation of the jig assembly 86 will be appreciated from FIGS. 5A, 18A-C and 19A-B. The jig assembly 86 is moveable from station to station by means of a hoist or crane 230 coupled through pulley 232 to the eyelet 126 by means of a hook 234. At one or more stations, the core assembly 10 is docked to a receiving mechanism configured to couple with one or both of the spindle assemblies 20, 22. When a move of the core assembly to another station is required, the hoist 230 positions the jig assembly 86 over the core assembly 10 and lowers the jig assembly into the engagement position as shown in FIGS. 18A and 19A. The lifting arms 108, 109 and 110, 111 are unlatched and have been manually pivoted by means of the handles 122 into the spread, open, or divergent orientation, whereby allowing receipt of the core spindles 20, 22 therebetween. The latch mechanism 120 of each pair of lifting arms is in the up or unlatched position as shown and the core spindle(s) are in docking engagement with station coupling device(s).

The jib assembly 86 is lowered over the core by the hoist 230 until the rollers 116 are positioned at the bottom surface of the core spindles 20, 22 in four places. The arms are then repositioned so that the arms come closer together into a closed or convergent orientation as shown in FIGS. 5B, 18B and 19B. The latch mechanisms 120 are pivoted into the shown latched position over the latch pin 136. The lock pin 140 in each mechanism 120 is moved beneath the latch pins 136 to lock the arms into the closed position. The crane 230 is then raised higher until the rollers 116 contact the core spindles 20, 22. The crane is then slowly jogged higher, until the weigh scale assembly 142 indicates that the crane is supporting the weight of the core as well as the jig assembly 86. Indicator arm 146 moves into alignment opposite the scale mark 144 to indicate when the transfer of core weight to the crane/jig assembly is complete and signifies that release of the core assembly from the station may safely and easily be effected. The core is then released from the tire building or curing station and can be moved by the crane to the desired location. Release of the core from the station core-coupling mechanism to which it is docked is facilitated by the support of its weight by the jig assembly and crane.

Operation of the built in weigh scale in the jig assembly 86 as described previously gives the operator an indication that the crane lifting force is the same as the core weight. It will be noted that the jig assembly 86 in the core engaged position shown does not interfere with the coupling ends of the spindle assemblies 20, 22. Thus, support of the core assembly 10 by the jig assembly may be effected while the core assembly is still docked to a tire building or curing station. Moreover, once the core assembly is undocked from the station and supported fully by the jig assembly and crane, the coupling ends of the spindle assemblies 20, 22 remain unobstructed for coupled engagement with the core handling mechanism 170 and for subsequent docking to another tire building or curing station. The rollers 116 and the mechanism 170 may effect an axial reorientation of the core assembly 10 without interfering with or interference from the operation of the jig assembly 86. It will also be appreciated that the core assembly 10 may be moved with the mechanism 170 attached. Also, it will be noted that contact between the tire 84 supported by the core assembly 10 and the jig assembly 86 and core handling mechanism 170 is avoided throughout the procedures. Potential damage to the green or cured tire carried by the core assembly 10 from contact with either apparatus is thus eliminated.

From the foregoing, it will be apparent that engagement and lifting of the core assembly 10 is both expedient and efficient. The straddling of the core by the jig assembly 86 and its base 88 makes it less likely that a tire on the core will be damaged by inadvertent contact. The latching mechanism employed that affixes pairs of lifting arms to both spindle assemblies 20, 22 is non-powered, relatively light, inexpensive to manufacture, and relatively uncomplicated. The center of gravity of the jig assembly 86 is preferably substantially close to that of the core and the jig assembly 86 is proximally positioned to the core to enable a lifting of the core by the jig assembly without tilting and without the need for significant counterbalance weight. In addition, the independent axial orientation of the core facilitated by the core handling mechanism 170 and rollers 116 allow for a convenient and easy manual alignment of the core to mating latching apparatus within a tire build or curing line station.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A core handling apparatus for a tire building core having a toroidal core assembly coupled to first and second spindle mechanisms extending from opposite sides of a core assembly, the core handling apparatus comprising:
a base plate;
a latching mechanism mounted to the base plate and operably inserting into an axial opening at a remote end of a first spindle mechanism, the latching mechanism having a latching member operably engaging the first spindle mechanism from within the axial opening;
a handle mechanism mounted to the base plate and extending outward, the handle mechanism operably rotating under manual power to rotate the core assembly and the first spindle mechanism into alternate angular orientations.

2. The core handling apparatus of claim 1, wherein the latching mechanism moves between a radially retracted position for operable insertion into the first spindle mechanism axial opening and a radially extended position from within the first spindle mechanism axial opening to engage the first spindle mechanism.

3. The core handling apparatus of claim 2, wherein the latching mechanism comprises at least a first latch member and a second latch member; a plurality of linkage arms, each arm pivotally coupled at an inward end to a bracket member; at least a first latch member and a second latch member pivotally coupled to an outward end of a respective linkage arm and pivoting between a retracted position and an extended position.

4. The core handling apparatus of claim 3, wherein the bracket member is mounted to an actuator rod lower end, the actuator rod extending through a base plate through opening and axially moving within the opening between a downwardly extended position and a retracted position to operably move the first and second latch members between the retracted and extended positions.

5. The core handling apparatus of claim 4, further comprising a locking mechanism secured to an upper end of the actuator rod for retaining the actuator rod in the extended position.

6. The core handling apparatus of claim 1, wherein the handle mechanism comprises at least a first handlebar and a second handlebar mounted to the base plate, each said handlebar extending a remote end outward beyond a peripheral boundary of the first spindle assembly in an operable position, and the first handlebar and the second handle bar having a gripping portion at the remote end.

7. The core handling apparatus of claim 1, further comprising:
a jig assembly comprising a support frame; a spreader mechanism; a first arm mechanism and a second arm mechanism, each arm mechanism having a first arm and a second arm coupled to the support frame with each first arm and second arm coupled to a respective spreader mechanism, the first and second arms of each arm mechanism admitting a respective spindle mechanism from a respective side of the core assembly therebetween, the jig assembly having a plurality of roller members at a lower end of each arm mechanism for operable support of the first spindle mechanism and the second spindle mechanism for operably enabling an axial rotation of the spindle mechanisms upon the roller members.

8. The core handling apparatus of claim 1, further comprising a hoisting apparatus for selectively elevating and lowering the tire building core by the arm mechanisms with the latching mechanism within the axial opening of the first spindle mechanism.

9. The core handling apparatus of claim 8, wherein further comprising:
a jig assembly comprising a support frame; a spreader mechanism; a first arm mechanism and a second arm mechanism, each arm mechanism having a first arm and a second arm coupled to the support frame with each first arm and second arm coupled to a respective spreader mechanism, the first and second arms of each arm mechanism admitting a respective spindle mechanism from a respective side of the core assembly therebetween, the jig assembly having a plurality of roller members at a lower end of each arm mechanism for operable support of the first spindle mechanism and the second spindle mechanism for operably enabling an axial rotation of the spindle mechanisms upon the roller members.

10. The core handling apparatus of claim 1, wherein the base plate abuts a rearward end of the first spindle mechanism with the latching mechanism inserted within the axial opening of the first spindle mechanism.

11. A core handling apparatus for a tire building core having a toroidal core assembly coupled to first and second spindle mechanisms extending from opposite sides of a core assembly, the core handling apparatus comprising:
a base plate;
a latching mechanism mounted to the base plate and operably inserting into an axial opening at a remote end of a first spindle mechanism, the latching mechanism having a latching member operably engaging the first spindle mechanism from within the axial opening;
a handle mechanism mounted to the base plate and extending outward, the handle mechanism operably rotating under manual power to rotate the core assembly and the first spindle mechanism into alternate angular orientations; and
a plurality of support rollers rotatably supporting the tire building core by the first spindle mechanism and the second spindle mechanism during said rotation of the core assembly into alternate angular orientations.

12. The core handling apparatus of claim 11, wherein further comprising a jig assembly for operably elevating and lowering the tire building core and support rollers.

13. The core handling apparatus of claim 11, wherein the handle mechanism comprises at least a first handlebar and a second handlebar mounted to the base plate, each said handlebar extending a remote end outward beyond a peripheral boundary of the first spindle assembly in an operable position, and the first handlebar and the second handle bar having a gripping portion at the remote end.

14. The core handling apparatus of claim 13, wherein the latching mechanism moves between a radially retracted position for operable insertion into the first spindle mechanism axial opening and a radially extended position from within the first spindle mechanism axial opening to engage the first spindle mechanism.

15. A method for reorienting a tire building core of the type having a toroidal core assembly coupled to first and second spindle mechanisms that extend from opposite respective sides of a core assembly, the method comprising:
inserting a latch mechanism in a retracted condition into an axial opening at a remote end of a first spindle mechanism;
moving the latch mechanism into a radially extended position within the axial opening;
engaging the first spindle mechanism within the axial opening by a latching member with the latch mechanism in the extended position.

16. The method of claim 15, further comprising: applying rotation inducing torque to the first spindle mechanism through rotation of the latch mechanism by a handle mechanism connected to the latch mechanism and operably positioned adjacent to the first spindle mechanism.

17. The method of claim 15, further comprising releasably locking the latch mechanism in the extended position.
